(19) United States
(12) Patent Application Publication
(10) Pub. No.: US 2014/0280629 A1
(43) Pub. Date: Sep. 18, 2014

(54) METHOD AND SYSTEM FOR OPTIMIZING COMPOSER PROMPTS FOR POSTING IN A SOCIAL NETWORKING SYSTEM

(71) Applicants: Yigal Dan Rubinstein, Los Altos, CA (US); Aditya Koolwal, San Francisco, CA (US); Sergey Markov, Menlo Park, CA (US); Christopher Cox, San Francisco, CA (US)

(72) Inventors: Yigal Dan Rubinstein, Los Altos, CA (US); Aditya Koolwal, San Francisco, CA (US); Sergey Markov, Menlo Park, CA (US); Christopher Cox, San Francisco, CA (US)

(21) Appl. No.: 13/841,175

(22) Filed: Mar. 15, 2013

(51) Int. Cl. H04L 12/58

(52) U.S. Cl. CPC H04L 51/32
USPC 709/206

(57) ABSTRACT

A computer-implemented method for generating a composer prompt to induce a user to post a message at a social network system is disclosed. The method starts with retrieving information about the user, the user information being stored in a profile at the social networking system. It assesses the user information and temporal information to determine content and format of the composer prompt. Then the method generates a new composer prompt based at least partially on an assessment of the information and display the new composer prompt to the user.

### FIELD

The embodiments of the invention are related to the field of Internet messaging. More specifically, the embodiments are related to creating and managing composer prompts for posting in a social networking system.

### BACKGROUND

Today user generated content on the Internet has seen exponential growth. Posting, viewing, and replying to messages on a social network site are growing to become a daily routine of a significant percentage of Internet users. An August 2011 survey by the Pew Internet & American Life Project found that 65% of American online adults use social networking sites, up dramatically from 8% found by the same organization in a February 2005 survey. Messaging through a social network site allows people to brainstorm ideas, share interests, exchange experiences, and generally “stay in touch” with family, friends, associates, and the world at large. Yet, many people remain reluctant to post messages on a social network site.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to affect such feature, structure, or characteristic in connection with other embodiments whether or not explicitly described.

FIG. 1 is a block diagram illustrating a social networking system according to one embodiment of the invention.

FIG. 2 illustrates an example social graph 200 that may be used by a social networking system.

FIG. 3 is a flow diagram illustrating a method of optimizing a composer prompt in a social networking system according to one embodiment of the invention.

FIG. 4 is a block diagram illustrating an embodiment of a social networking system managing composer prompts according to one embodiment of the invention.

FIG. 5 is a block diagram illustrating a social networking system generating composer prompts according to one embodiment of the invention.

FIGS. 6A-D are block diagrams illustrating a variety of customized composer prompts of a social networking system according to embodiments of the invention.

FIG. 7 illustrates a computing system in which embodiments may operate, be installed, integrated, or configured.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description. It will be appreciated, however, by one skilled in the art that the invention may be practiced without such specific details. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described. In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The operations of the flow diagram will be described with reference to the exemplary embodiment of FIG. 3. However, it should be understood that the operations of flow diagrams can be performed by embodiments of the invention other than those discussed with reference to FIGS. 2 and 4, and the embodiments discussed with reference to FIG. 3 can perform operations different than those discussed with reference to the flow diagrams of FIGS. 2 and 4.

Operators of social networking sites have attempted to encourage more posting on their sites. For example, some operators provide a “cue” to a user for the user so that the user may be more willing to post a message. One way to implement the cue is through a composer prompt. A composer is a text editable field that allows a user to communicate messages to others. For example, a user may type in a comment into a composer and then post that comment onto a social networking site. A composer prompt may be generated by an operator of a social networking site and it stays in a composer field, which is the field for a user to create a message. An example of a composer prompt is a greyed out text (e.g., “what is on your mind?”) and it disappears after the user starts typing in the composer field. When the message is posted on the social networking site, the composer prompt may be displayed along with the user generated message so that a viewer of the message understands the context of the user generated message.

Embodiments of Social Networking Systems

FIG. 1 is a block diagram illustrating a social networking system according to one embodiment of the invention. Referring to FIG. 1, user devices 102 and 122 communicate with social network system 106 through network 104. Network 104 may be any type of network such as a local area network (LAN), a wide area network (WAN) such as Internet, a corporate intranet, a metropolitan area network (MAN), a storage area network (SAN), a bus, or a combination thereof, wired and/or wireless. User devices 102 and 122 may be any device communicatively coupled to network 104, such as computers, mobile devices (cellphones, wearable Internet devices, automobile based Internet devices, and etc.), smart TVs/setup boxes, Internet gaming devices, a personal digital assistant (PDA), a Web enabled system, a media player, and a “thin” client, etc.

Social networking system 106 operates a social network site, platform, or an online service that facilitates the building of social networks or social relations among people and sometimes between people and other entities such as corporations. For simplicity of discussion, a social network site is used in various embodiments discussed herein below. It will be appreciated, however, by one skilled in the art that the invention may be practiced in a social network platform or an online service. Social networking system 106 allows users to designate other users or entities as connections, or otherwise connect to, or form relationships with, other users or entities. Additionally, users can contribute and interact with their connections, use applications, join groups, list and confirm attendance at events, invite connections, and perform other tasks that facilitate social interaction. External applications also use the services of a social networking system to allow authenticated users to incorporate some of the above social interactions with use of the external applications. Note that the terms “message” and “post” are used interchangeably within the specification unless noted otherwise.

For managing composer prompts, social networking system 106 may contain prompt creator 112, which is the module coordinating prompt creating. Prompt creator 112 interacts with knowledge storage 108 to extract knowledge to tailor a prompt to a targeted user. As discussed herein below in detail, knowledge storage 108 may store a variety of information or characteristics that is useful for prompt creation. In one embodiment, knowledge storage 108 contains information about users, communities the users belong to, temporal data, and worldly events. Knowledge storage 108 represents server or cluster of servers managing knowledge, information, or characteristics relating to prompt management and other functions for social networking system 106. Knowledge storage 108 may include a variety of storage devices, including a file server (e.g., an appliance used to provide network attached storage (NAS) capability), a block-based storage server (e.g., used to provide SAN capability), a unified storage device (e.g., one which combines NAS and SAN capabilities), a nearline storage device, a direct attached storage (DAS) device, a tape backup device, or essentially any other type of data storage device. Note in some embodiments, knowledge storage 108 and prompt creator 112 are integrated into one entity within social networking system 106. In other embodiments, instead of being implemented within, one or both modules are implemented outside but communicatively coupled with social networking system 106.

In one embodiment, a user may log into a social networking site through user devices 102. Prompt creator 112 then determines what composer prompt is appropriate for the user at the moment of time if a new prompt is needed. Prompt creator 112 may make the determination based on information within knowledge storage 108. For example, when knowledge storage 108 contains information indicating that the user has recently traveled to Europe, prompt creator 112 may create a prompt like “How was your European trip, Ferris?” assuming the user's first name being Ferris. Ferris may be induced to write something about his European trip in the composer field. After the message is posted on the social networking site, another user of the social networking site, like a user using user devices 122, may read the message and she may comment or reply to the message, or forward the message on to her friends. Ferris' post then may generate numerous responses on the social networking site.

A created thread stemming from a customized prompt helps influence content creation by prompting people to communicate and tell stories. By making sharing experience easier, a personally tailored composer prompt boosts the social networking site's ability to empower its users to build and maintain relationships and makes the social networking site an indispensable part of its users' life. The snowball effect triggered by a thoughtful composer prompt may also give the social networking system more information about all the users involved. The additional knowledge can then be added to knowledge storage 108 and make future customized prompts better at evoking more memories and drawing more message posting.

A social networking system may store records of users and relationships between users in a social graph comprising a plurality of nodes and a plurality of edges connecting the nodes. The nodes may comprise a plurality of user nodes and a plurality of concept nodes. A user node of the social graph may correspond to a user of the social networking system. A user may be an individual (human user), an entity (e.g., an enterprise, business, or third party application), or a group (e.g., of individuals or entities). A user node corresponding to a user may comprise information provided by the user and information gathered by various systems, including the social networking system. For example, the user may provide his or her name, profile picture, city of residence, contact information, birth date, gender, marital status, family status, employment, educational background, preferences, interests, and other demographic information to be included in the user node. Each user node of the social graph may have a corresponding web page (typically known as a profile page). For example, in response to a request including a user name, the social networking system can access a user node corresponding to the user name, and construct a profile page including the name, a profile picture, and other information associated with the user. A profile page of a first user may display to a second user all or a portion of the first user's information based on one or more privacy settings by the first user and the relationship between the first user and the second user. A concept node may correspond to a concept of the social networking system. For example, a concept can represent a real-world entity, such as a movie, a song, a sports team, a celebrity, a group, a restaurant, or a place or a location. An administrative user of a concept node corresponding to a concept may create or update the concept node by providing information of the concept (e.g., by filling out an online form), causing the social networking system to associate the information with the concept node. For example and without limitation, information associated with a concept can include a name or a title, one or more images (e.g., an image of cover page of a book), a web site (e.g., an URL address) or contact information (e.g., a phone number, an email address). Each concept node of the social graph may correspond to a web page. For example, in response to a request including a name, the social networking system can access a concept node corresponding to the name, and construct a web page including the name and other information associated with the concept. An edge between a pair of nodes may represent a relationship between the pair of nodes. For example, an edge between two user nodes can represent a friendship between two users. For another example, the social networking system may construct a web page (or a structured document) of a concept node (e.g., a restaurant, a celebrity), incorporating one or more selectable buttons (e.g., “like”, “check in”) in the web page. A user can access the page using a web browser hosted by the user's client device and select a selectable button, causing the client device to transmit to the social networking system a request to create an edge between a user node of the user and a concept node of the concept, indicating a relationship between the user and the concept (e.g., the user checks in a restaurant, or the user “likes” a celebrity, etc.). For example, a user may provide (or change) his or her city of residence, causing the social networking system to create an edge between a user node corresponding to the user and a concept node corresponding to the city declared by the user as his or her city of residence. In addition, the degree of separation between any two nodes is defined as the minimum number of hops required to traverse the social graph from one node to the other. A degree of separation between two nodes can be considered a measure of relatedness between the users or the concepts represented by the two nodes in the social graph. For example, two users having user nodes that are directly connected by an edge (i.e., are first-degree nodes) may be described as “connected users” or “friends.” Similarly, two users having user nodes that are connected only through another user node (i.e., are second-degree nodes) may be described as “friends of friends.”

A social networking system may support a variety of applications, such as photo sharing, on-line calendars and events, gaming, instant messaging, and advertising. For example, the social networking system may also include media sharing capabilities. Also, the social networking system may allow users to post photographs and other multimedia files to a user's profile page (typically known as “wall posts” or “timeline posts”) or in a photo album, both of which may be accessible to other users of the social networking system depending upon the user's configured privacy settings. The social networking system may also allow users to configure events. For example, a first user may configure an event with attributes including time and date of the event, location of the event and other users invited to the event. The invited users may receive invitations to the event and respond (such as by accepting the invitation or declining it). Furthermore, the social networking system may allow users to maintain a personal calendar. Similarly to events, the calendar entries may include times, dates, locations and identities of other users.

FIG. 2 illustrates an example social graph 200 that may be used by a social networking system. In the example of FIG. 2, social graph 200 includes user nodes 201, concept nodes 202, and edges 203 between nodes. An edge 203 between a pair of nodes may represent a relationship (or an action) between the pair of nodes. For example, user “G” is a friend of user “B”, user “C”, and user “E”, respectively, as illustrated by the edges between user nodes “G” and “B”, between user nodes “G” and “C”, and between user nodes “G” and “E.” For example, users “C”, “E”, and G″ watch (or “like”) a TV show “American Idol”, as illustrated by the edges between the “American Idol” concept node and user nodes “C”, “E”, and G″, respectively. Similarly, the edge between the user node “B” and the concept node “Palo Alto” may indicate that user “B” declares “Palo Alto” as his or her city of residence. The edge between the user node “B” and the concept node “Macy's” may indicate that user “B” likes the store “Macy's.” Of course, social graphs can be much larger than social graph 200 illustrated in FIG. 2, and the number of edges and/or nodes in a social graph may be many orders of magnitude larger than that depicted herein.

As described earlier, an edge between a pair of nodes may indicate a direct relationship between the pair of nodes. An edge may be directed and connect an ordered pair of nodes. For example, an edge connecting a user node corresponding to a user and a concept node corresponding to a city may be directed (i.e., the user lives in the city). An edge may be undirected, as a pair of nodes connected by the edge does not have a particular order. For example, an edge connecting two user nodes can be undirected as the edge indicates a friendship between two users corresponding to the two user nodes. As described earlier herein, a degree of separation between any two nodes is defined as the minimum number of hops required to traverse the social graph from one node to the other. Thus, for user “B”, the nodes for users “A”, “C”, and “G” are all one hop away and are thus users of first-degree and may be described as “connected to” or “friends” of user “B.” However, from the standpoint of user “B”, the nodes for users “E”, “F”, and “K” are considered to have a second-degree of separation because the shortest path from user “B” to any of these nodes requires transiting through one other node. Thus, from the standpoint of user “B”, users “E”, “F”, and “K” are deemed “friends of friends.” Accordingly, user “B” is either a “friend” or a “friend of a friend” with every other user in the graph except for user “H”, as the shortest path between user “B” and user “H” transits through two user nodes.

Embodiments of Optimizing Composer Prompts

FIG. 3 is a flow diagram illustrating a method of optimizing a composer prompt in a social networking system according to one embodiment of the invention. This figure includes steps that are optional depending on the specific implementation and such steps are shown with dashed boxes. Method 300 may be performed at social networking system such as system 106 in FIG. 1. In the description below, a composer prompt is a field text editable field of a web page or in a mobile application that allows the user to post desired text. However, a composer prompt may also allow a user to post other messages that contain at least one of a text, a video, an audio, and a hyperlink to a location on the Internet, or a combination of two or more types of content.

Referring to FIG. 3, at reference 302, the social networking system retrieves information about a user. Users of social networking sites login into that site (e.g., on a mobile device application or through a browser). This login provides the social networking system with an identifier of the person currently using the device that logged in that is tied to a profile for that user. Profile information may include one or more of: name, age, sex, educational information, employment, friends, location (temporal or permanent), interests, etc. In one embodiment, user does not need to login into the site, and the social networking system uses factors discussed herein (e.g., user information and temporal information) to determine a customized prompt. For example, without a user's login, the social networking system may determine to use a Valentine's Day related prompt around February 14 in a country celebrates Valentine's Day.

Optionally, at reference 304, the system determines whether a customized composer prompt should be displayed. As noted above, it may be desirable to customize composer prompts to facilitate more posts. The system may generate a composer prompt according to a refresh schedule to keep the site/application interesting. For example, the system may set to refresh a composer prompt every day or every login by the user. The system may also set to refresh the composer prompt after a user has not posted for a determined duration (e.g., no message posting three hours after login or no posts for three weeks). The refresh schedule may be also related to recent activity on the social networking system or around the location of the user. For example, refresh schedule may depend on whether other users have just checked in the social networking system, or the user has just reached a different physical location. The refresh schedule may be configurable and a combinational refresh schedule may be used (e.g., a new composer is determined to be desirable at after login and three hours without message posting). In addition, the refresh schedule may not be the same for all users, and some users may be given a higher refresh rate than the others. For example, an avid user who generally posts more than a dozen messages per day will be set to have a new composer prompt every hour while a more passive user may be set to have a new composer prompt every couple of days. In one embodiment, the system may generate a composer prompt on demand. The system may provide a selection (e.g., a checkbox), and once a user makes the selection, the system generates a customized composer prompt. The system may generate multiple prompts until the user finds one interesting.

At reference 306, assuming that a new composer prompts is desirable, the system assesses the information it has to determine the content of the custom composer prompt. The information the system has access to may be a variety of information types. For example, the information may include temporal information about the moment of the user's login or the moment of creating the prompt, or demographics of the user and demographic composition of a community that the user being a member of. The information may also include noteworthy events in the real world (e.g., the presidential result of a just completed election) or a virtual world (e.g., a close friend just learned archeology in the World of Warcraft game). The system may also winnow through the past activities by the user or other users in a community that the user belongs to and glean useful information for inducing the user to post a message.

The system may rank all of the available information. For example, the system may consider temporal information the most important factor for a particular user based on the particular user's past response to a composer prompt based on time of the week. The system may then assign high relevancy value to time of a week characteristics. Note the assessment may be customized to a particular user and it may change over time, thus ranking of available characteristics may also change from time to time. For example, an impactful event (e.g., a local team winning the World Series) may take precedence over time of a week characteristics for the particular user, even though generally temporal characteristics have been the determining factor for the particular user in the past. Also, the assessment may be revised based on user's responses to generated composer prompts in the past. That is, based on user's responses to previous composer prompts, the system will reassess various information. In one embodiment, the system may allow the user to configure the kind of information the user likes to be used for composer prompt generation.

At reference 308, the system generates a custom composer prompt based on the assessed information that the system has access to. The generated prompt may be aimed at maximizing the chance that the particular user responds with a message creation in one embodiment. In another embodiment, the system may also consider commercial interests of the operator of the system or a third party in generating a prompt. For example, when a composer prompt about weather and a movie are similarly useful in drawing a particular user to post message, the system may choose to generate a composer prompt about a recently released movie, when the studio releasing the movie is willing to sponsor such a prompt.

A generated composer prompt may be customized not only in its content, but also in its format. The format of a composer prompt is the way that the composer prompt is presented to a user, including language, syntax, font, layout and other factors. For example, some users respond better when the composer prompt is in the user's native language, thus a prompt may be generated using the user's native language instead of say English. Also, some users respond better when the prompt is in the format of narrative instead of questioning. Other users may respond better when given proper titles (e.g., a medical doctor John Doe may be more likely to write a post/message when addressed to as Dr. Doe than John in a composer prompt). Still others may like to be called a more playful name (e.g., Mrs. Soccer mom). Thus, in generating a customized composer prompt, the system may consider the proper content and format/syntax. The system may learn what prompts are successful for a user (causes a post) and use that information for later prompt decisions.

At reference 310, the system displays the generated custom composer prompt to the user. The generated custom composer prompt may be displayed within a composer field in one embodiment. In another embodiment, the composer prompt may be displayed outside of the composer field. The composer prompt may disappear after the user starts to type in the composer field in one embodiment; yet in another embodiment, the composer prompt will be kept on display to the user. In one embodiment, along with the composer prompt, the system may display related advertisement somewhere on the user's page. When the composer prompt is something like “how was the concert last night?” an advertisement to promote the next concert by the same music group may be displayed somewhere in the page. In other words, in displaying a customized composer prompt, the system may consider the user's page as a whole and further enhance user's experience in posting message and/or advance its commercial interest.

Optionally, the statistics of a user's response to the generated composer prompt is collected at reference 313. The collected statistics of user's responses may be used to fine tune future prompt generation in one embodiment. The collected statistics may also be given to a third party for the commercial interests of the operator of the system. For example, by analyzing a response rate of a third party sponsored prompt, the third party may adjust a “tagline” it uses for future prompt-based or other-media-based advertisement.

Note that although the steps are discussed in the order illustrated in FIG. 2, some embodiments may not operate following the illustrated order. Some steps may be performed concurrently. For example, references 306 to 310 may be integrated into one step, and usefulness of characteristics may be used to determine two or more of the content, syntax, and corresponding advertisement at the same time. Also, customized prompts may be generated considering only customized syntax or customized advertisements on the user page with generic content.

Embodiments of Systems to Manage Composer Prompts

FIG. 4 is a block diagram illustrating an embodiment of a social networking system that manages composer prompts according to one embodiment of the invention. Social networking system 406 is similar to social networking system 106 of FIG. 1 and the same or similar references indicate elements or components having the same or similar functionalities. In addition to social network system 406, user devices 402 is used by a user to create messages while user devices 422 is used by another user to review the created messages. Both user devices 402 and 422 are communicatively coupled to social networking system 406.

Social networking system 406 contains knowledge storage 408 and prompt creator 412. In one embodiment, knowledge storage 408 is implemented within prompt creator 412 instead of being communicatively coupled to prompt creator 412 as shown in FIG. 4.

Prompt creator 412 may contain a variety of modules needed to create a composer prompt. In one embodiment, prompt creator 412 contains scheduler 414. Scheduler 414 is configured to determine prompt generating schedules for users of the social networking system. Scheduler 414 may be configurable on a per user basis, either by the user or by the system. When a schedule is configured by the system, the system may set a prompt refresh schedule based on a user's activity—for example, the more messages the user creates, the more quickly a new prompt is generated. The refresh schedule may be also related to recent activity on the social networking system or around the location of the user. For example, refresh schedule may depend on whether other users have just checked in the social networking system, or the user has just reached a different physical location. Scheduler 414 notifies prompt creator 412 to generate a new composer prompt, and the notification may result from a schedule of user login counts (e.g., a new composer prompt is generated every three logins), a duration count (e.g., a new composer prompt every two days), or some combination thereof. In one embodiment, scheduler 414 is implemented outside of and communicatively coupled with prompt creator 412. Note scheduler 414 may also schedule a prompt creation based on user's demand instead of a certain schedule.

Knowledge storage 408 may contain user data module 452, community data module 454, temporal data module 456, location related data module 458, sponsor data module 460, and prompt statistics collector module 462. These modules may be communicatively coupled via interconnect 430, which may be a bus connection in one embodiment. Note some modules within knowledge storage 408 may be integrated together, and some modules may not be implemented within knowledge storage 408 and they may be implemented as standalone entities that communicatively coupled to knowledge storage 408. Also, when social networking system 406 supports only a subset of feasible features for optimized composer prompts, some modules illustrated in FIG. 4 may not be implemented.

User data module 452 stores user related characteristics that may include user demographics, user activities, and other feasible user profiling data on the social networking site. The user related characteristics are collected, stored, or used in accordance with the local laws and user's privacy settings. User demographic data includes a user's gender, race, national origin, religion, age, marital status, disability, sexual orientation, education level, and socioeconomic status. User activities include messages the user has created, message threads the user has followed, communities the user has been actively involved, etc. This data is useful for social networking system 406 to customize composer prompts to the user's favor. For example, a user from Europe may be more likely to respond to a soccer themed composer prompt than a user from the United States due to popularity discrepancy of the sport between the two continents, and using this national origin characteristics of users may help social networking system 406 to create a “better” composer prompt for a user of a particular national origin. For an another example, a college-educated user with a computer science degree may be more eager to respond to a composer prompt regarding an article she just read about computer hacking than another user educated in a different field who also read the same article. The characteristic of a user's education level thus is also useful in determine usefulness of a particular composer prompt. In some embodiment, user characteristics are inferred or predicted in accordance with local laws and privacy setting, see for example U.S. patent application Ser. No. 12/978,265, entitled “Contextually Relevant Affinity Prediction in a Social Network System,” and U.S. patent application Ser. No. 13/167,700, entitled “Inferring Topics from Social Networking System Communications Using Social Context,” incorporated by reference herein.

In addition to the selecting content of a custom composer prompt, the characteristics of a user are also useful to determine the proper format/syntax to use. For example, a mature user may prefer to be addressed by his last name instead of his first name in some cultures. Also, users of some national origins are more responsive to a composer prompt formatted as narrative instead of a question thus the system should use narrative in creating composer prompts for these users. In addition, certain users are more responsive to composer prompts when the prompts are in the native language the users speak, thus the system may generate prompts using the user's native language. Note each user has her own characteristics, thus demographic characteristics are only useful to an extent. A user's past activities on the social networking site and her past response to customized composer prompts may be used to in addition or in alternative in determining usefulness of the content and format of prompts.

Community data module 454 stores community related characteristics. A particular user that is in need of composer prompt may belong to one or more communities and community data module 454 includes characteristics of the community the user belongs to. The characteristics of the community may include demographic composition of genders, races, national origins, religions, ages, marital statuses, disabilities, sexual orientations, education levels, and socioeconomic statuses. In addition, the characteristics of the community may include activities of users in the community engaged in, including message posted, forwarded, commented, or rated (e.g., “liked”), composer prompts responded. Demographic characteristics of a community serve a similar purpose as demographic characteristics of the particular user, and the system may use the general responses by a community the particular user belongs to forecast the likelihood of the particular user responding to a prompt with a particular type of content and format.

Temporal data module 456 stores time related characteristics. Temporal data may include characteristics of a particular time of the day, day of the week, month, or year. For example, a composer prompt about coffee in the morning may be more likely to draw message posting by a user then the same prompt in the evening as more people drink coffee in the morning and the short term memory may compel the user to comment one way or another about coffee. For another example, a composer prompt about the Valentine's Day may be more likely draw message posting during the days leading to February 14^{th} than say a random day in August. Temporal data may also include national holidays, celebrations per locales. It includes events relating to history, be it at the world level, national level, or even community level. For example, a composer prompt relating to World War II on June 6 (the D-Day) may compel someone familiar with that history to write a post relating to the war or war in general. Temporal data may contain information relating to contemporary events in the real world or virtual world. The real world contemporary events may be events in the news (the scores of the latest Super Bowl) or in the local community only (the win by the local Little League). The virtual world contemporary events may be events in an online world (e.g., the user reaches friend count of 500 on a social networking site). Temporal data may be tailored to each user and include events that the user is attending or has been invited to. Each user may have a different preference in response to temporal data, and prompt creator 412 may select high relevant ones (ones that tend to draw response from the user) to generate a composer prompt for the user.

Location related data module 458 stores location data related to a user. As mobile devices become ubiquitous, many users of a social networking site logs in to the social networking site from a mobile device. Many mobile devices contain location tracking functionalities, and social networking system 406 may collect location information from a mobile device a user uses. Location information also include other users within a certain radius of the user's current physical location. The collected location information may be stored in located related data module 458 and be used for generating a composer prompt for the user. For example, from a mobile device, the system may learn in real-time that the user is a cross-country trip from San Francisco to New York (e.g., the physical location the user at the first login was at San Francisco and the physical location the user at the second login was at New York, the JFK Airport). The system may choose not to generate a travel related composer prompt during the trip. Rather, the system may generate a composer prompt asking about the trip several days after the user has been at her destination. In this way, the user has a chance to reflect and may be more willing to share events and observations during her travel. Location related data may also be very useful for advertisement purpose. A targeted advertisement with location related characteristics embedded may make a veiled commercial through composer prompt easier to tolerate (e.g. a customized prompt for a user at Stadium X being: “80% fans of Stadium X have tried Die Hard Pretzels, have you?”).

Sponsor data 460 stores characteristics related to third party sponsors of composer prompts. A third party sponsor may have a certain criteria for targeted advertisement relating to composer prompts, and the criteria may be stored in sponsor data 460. A sponsor may target certain demographics for certain promotion, and social networking system 406 can match the sponsor's request stored in sponsor data 460 with user data 452 and/or community data 454 and generate customized composer prompt that are more likely to draw the user's response. The customized composer prompt may have an added benefit outside social networking system 406 as the user may learn more about the sponsor thus may view the sponsor's products more favorably and become more likely to purchase the sponsor's products.

Prompt statistics collector 462 collects statistics associated with composer prompts. The collected statistics may include how often a user reacts to a composer prompt, the type of content and format/syntax the user reacts to, how often a user reacts to a sponsor-inspired prompt, etc. The collected statistics can be used in various ways in social networking system 406. It may help the system determine whether customized prompt is needed for certain users. Some power users cannot wait to tell the world what is on their mind and they may never take advantage of what customized prompts offer. At the other extreme, some casual users may only share what they like to share on the site regardless of what customized prompt alludes to. Social networking system 406 may compute a correlation between generated customized composer prompts and user generated messages to determine whether customized prompts are useful for the user. Based on the determination, social networking system 406 may switch non-responsive users to generic prompts for a period and fine-tune customized prompts to the more responsive users. After the period, the system may try different customized prompts to the previously non-responsive users and see if anything changes. The collected statistics may help a sponsor to tailor prompts it favors to the users more likely to respond either online through message posting or offline through purchases (the system may learn the purchases through the user's messages online).

FIG. 5 is an exemplary method of generating composer prompts according to one embodiment of the invention. Method 500 may be performed by social networking system 406. The method starts with generating content feed at reference 502. The system collects content feed when it needs to generate a customized composer prompt, thus it may collect content feed specifically for a particular user. Method 500 contains three steps: content collection in content feed box 502, content selection in content selector box 505, and format selection in format selector box 506. Information blocks within each box illustrate how information is organized and utilized and these information blocks may be stored in various data modules of knowledge storage 408 in FIG. 4.

Referring to FIG. 5, content may be fed from a variety of sources, including temporal information 512, location information 513, activity information 511, event information 515, and sponsor information 517. For example, the sources may include news media outlet (ABC, CBS, NBC, CNN, etc.), applications on the social networking system (Game feed, application center, etc), user location update, and local event update. The various types of information may be stored in various data modules in knowledge storage 408. For example, temporal information 512 and event information 515 may be stored in temporal data module 456; location information 513 may be stored in location related data module 458; activity information 511 may be stored in either user data module 452 or community data module 454 as activity information may include activities of both a particular user and the communities the particular user belongs to; and sponsor information 538 may be stored in sponsor data module 460. The information may be updated in real-time. For example, different temporal information will be fed at a different hour of the day. Similarly, as the particular user moves from one location to another, location information is updated to feed to content feed. Not all types of information are needed for generating a customized composer prompt and a social networking system may only implement to collect a certain types of information and ignores others. Also note that the types of information listed herein above are not meant to be an exhaustive list and other types of information may also be used as content feed as long as it is considered useful to generate a customized composer prompt.

The content feed 502 is then filtered through content selector 505 to select a useful composer prompt. Content selector 505 may make the content selecting decision on the particular user's past response to a particular type of content or make the decision base on past response of majority of users within a community that the particular user belongs to. Thus content selector 505 may utilize information from user/community past response block 522. In some embodiments, content selection may be also based on user and community demographics information as shown in user demographics information block 525 and community demographics information block 526. As discussed herein above, because users in a particular demographic group may share common sentiment toward various contents of composer prompt, it is useful to consider demographic information of a particular user and demographic composition information of a community the particular user belongs to. The demographic information may be used as the starting point of content selection. “Stereotyping” based on demographics may not be accurate and sometimes it is against law. The system may use demographic information to adjust content selection based on user/community past response alone. In different embodiments, one or more blocks within content selector 505 may not be needed, and other blocks may be added to content selector 505. Through content selector 505, the system will select content for the particular user whom the customized prompt is for.

Then the system selects format for the selected content in format selector box 506. The format selection may be based on user/community past response block 532, user demographics block 535, community demographics block 536, and sponsor information block 538. Based on one or more of the information blocks, the system selects the format to use for the selected content. The format selection including the language to use (e.g., English versus the particular user's native language), narrative or question, using first name, last name, nickname, or adding title, and etc. Then the system generates a customized composer prompt with the selected content and selected format.

Note the order of method 500 may differ in different embodiments. For example, a social networking system may select a format of a composer prompt before selecting content of the composer prompt. In addition, in some embodiment, a social networking system may utilize only some functional boxes, for example, a system may use customized format and disregard selection of customized content considering implementation complexity of customizing content. In contrast, another system may use customized content without customizing format. In addition, some system may dedicate more effort to one types of customization than another. For example, a system may customize content to a particular user but all users within a particular demographics share the same format selection.

Exemplary Embodiments of Graphic User Interfaces (GUIs) for Composer Prompts

A number of graphic user interfaces (GUIs) may be deployed by a social networking system to display composer prompts. FIGS. 6A-D illustrate a variety of customized composer prompts of a social networking system according to embodiments of the invention. The composer prompts may be in a composer field of a user's page on a social networking site in one embodiment. In another embodiment, the GUI may be a pop-up box once a user logs in to the social networking site. A composer prompt may be displayed within the composer field or outside. In some embodiments, the composer prompt disappears once the user starts typing.

FIG. 6A illustrates a customized composer prompt using temporal characteristics at a social networking system according to one embodiment of the invention. The composer prompt created is, “Any plans for the long weekend, John?” The social network system may generate the prompt at a Friday before a long weekend holiday. The temporal characteristics may be considered most useful in drawing John to post a message as John may have been active in long weekends in the past as demonstrated by his past message (i.e., utilizing characteristics of the user's past activities on the social networking system to create the customized composer prompt).

FIG. 6B illustrates a customized composer prompt using demographic characteristics at a social networking system according to one embodiment of the invention. The composer prompt created is, “Ms. Bose, Mari Singh was just selected to be Miss Universe.” The prompt uses the user's last name, in narrative form, and it is about news that may be most intriguing to only certain demographics. The system may have determined that Ms. Bose is within the demographics that are most likely to respond to the prompt in such format with such content. The determination may be based on generalized demographic statistics based on national origin, or the activity patterns of users within a community associated with Ms. Bose, or past activities of Ms. Bose. Demographic characteristics can be integrated with user and community characteristics to formulate the content and format of a customized composer prompt.

FIG. 6C illustrates a customized composer prompt using user activity characteristics for advertisement at a social networking system according to one embodiment of the invention. The composer prompt created is, “New graphic search is awesome for cycling lovers!” The new graphic search is the subject of a promotion. The system may assess user activity characteristics and determine that the user is a cycling fan. Assuming the system has collected data indicating that some other cycling fans have used the new graphic search and have posted positive comments about the tool, the system may embed the promotion to the user and, instead of addressing the user by either her first name or last name, using a nickname “cycling lover” instead.

FIG. 6D illustrates a customized composer prompt using user demographic characteristics for advertisement at a social networking system according to one embodiment of the invention. The composer prompt created is, “Budweiser commercials: Voted #1 in this year's Super Bowl.” The likely subject of the promotion is product branded by Budweiser. The system may determine that prompt is appropriate because that the user is targeted demographics that the sponsor (Budweiser in this case) likes to reach, even if the user may not necessarily respond to such customized prompt. In other words, a customized prompt may be displayed for the commercial interests of the operator of the social networking system, not only at drawing the user's interest in posting a message.

FIG. 7 illustrates, in block diagram form, an exemplary computing system 700 in accordance with which embodiments may operate, be installed, integrated, or configured. The computing system 700 includes one or more microprocessors 705 and connected system components (e.g., multiple connected chips). Alternatively, the computing system 700 is a system on a chip.

The computing system 700 includes memory 710, which is coupled to the microprocessor(s) 705. The memory 710 may be used for storing data, metadata, and programs for execution by the microprocessor(s) 705. The memory 710 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 710 may be internal or distributed memory.

The computing system 700 also includes an audio input/output subsystem 715 which may include a microphone and/or a speaker for, for example, playing back music or other audio, receiving voice instructions to be executed by the microprocessor(s) 705, playing audio notifications, etc.

A display controller and display device 720 provides a visual user interface for the user. In an embodiment where the computing system 700 is an exemplary representation of the user device 102 of FIG. 1, the display device 720 may display the GUI windows illustrated in FIGS. 6A-6D.

The computing system 700 also includes one or more input or output (“I/O”) devices and interfaces 725, which are provided to allow a user to provide input to, receive output from, and otherwise transfer data to and from the system. These I/O devices 725 may include a mouse, keypad or a keyboard, a touch panel or a multi-touch input panel, camera, optical scanner, network interface, modem, other known I/O devices or a combination of such I/O devices. The touch input panel may be a single touch input panel which is activated with a stylus or a finger or a multi-touch input panel which is activated by one finger or a stylus or multiple fingers, and the panel is capable of distinguishing between one or two or three or more touches and is capable of providing inputs derived from those touches to the computing system 700.

The I/O devices and interfaces 725 may also include a connector for a dock or a connector for a USB interface, FireWire, Thunderbolt, Ethernet, etc. to connect the computing system 700 with another device, external component, or a network. Exemplary I/O devices and interfaces 725 also include wireless transceivers, such as an IEEE 802.11 transceiver, an infrared transceiver, a Bluetooth transceiver, a wireless cellular telephony transceiver (e.g., 2G, 3G, 4G), or another wireless protocol to connect the computing system 700 with another device, external component, or a network and receive stored instructions, data, tokens, etc.

It will be appreciated that one or more buses, may be used to interconnect the various components shown in FIG. 7.

In one embodiment, the computing system 700 is an exemplary representation of the user device 102 of FIG. 1. The computing system 700 may be a personal computer, tablet-style device, a personal digital assistant (PDA), a cellular telephone with PDA-like functionality, a Wi-Fi based telephone, a handheld computer which includes a cellular telephone, a media player, an entertainment system, or devices which combine aspects or functions of these devices, such as a media player combined with a PDA and a cellular telephone in one device. In another embodiment, the computing system 700 is an exemplary representation of a server computer in the social networking system 106 of FIG. 1. In other embodiments, the computing system 700 may be a network computer, server, or an embedded processing device within another device or consumer electronic product. As used herein, the terms computer, system, device, processing device, and “apparatus comprising a processing device” may be used interchangeably with the computing system 700 and include the above-listed exemplary embodiments.

It will be appreciated that additional components, not shown, may also be part of the computing system 700, and, in certain embodiments, fewer components than that shown in FIG. 7 may also be used in a computing system 700. It will be apparent from this description that aspects of the inventions may be embodied, at least in part, in software. That is, computer-implemented methods may be carried out in a computer system or other data processing system in response to its processor or processing system executing sequences of instructions contained in a memory, such as memory 710 or other non-transitory machine-readable storage medium. The software may further be transmitted or received over a network (not shown) via a network interface device 725. In various embodiments, hardwired circuitry may be used in combination with the software instructions to implement the present embodiments. Thus, the techniques are not limited to any specific combination of hardware circuitry and software, or to any particular source for the instructions executed by the computing system 700.

An article of manufacture may be used to store program code providing at least some of the functionality of the embodiments described above. Additionally, an article of manufacture may be used to store program code created using at least some of the functionality of the embodiments described above. An article of manufacture that stores program code may be embodied as, but is not limited to, one or more memories (e.g., one or more flash memories, random access memories—static, dynamic, or other), optical disks, CD-ROMs, DVD-ROMs, EPROMs, EEPROMs, magnetic or optical cards or other type of non-transitory machine-readable media suitable for storing electronic instructions. Additionally, embodiments of the invention may be implemented in, but not limited to, hardware or firmware utilizing an FPGA, ASIC, a processor, a computer, or a computer system including a network. Modules and components of hardware or software implementations can be divided or combined without significantly altering embodiments of the invention.

Different embodiments of the invention may be implemented using different combinations of software, firmware, and/or hardware. Thus, the techniques shown in the figures can be implemented using code and data stored and executed on one or more electronic devices (e.g., an end system, a network element). Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals—such as carrier waves, infrared signals, digital signals). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). Thus, the storage device of a given electronic device typically stores code and/or data for execution on the set of one or more processors of that electronic device.

While the flow diagrams in the figures herein above show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A computer-implemented method for generating a composer prompt to induce a user to post a message at a social networking system, the computer-implemented method comprising:
retrieving information about the user stored in a profile at the social networking system;
assessing the user information and temporal information to determine content and format of the composer prompt;
generating a new composer prompt based at least partially on an assessment of the information; and
displaying the new composer prompt to the user.

2. The computer-implemented method of claim 1, further comprising:
determining whether a new composer prompt is desirable based on a prompt refresh schedule.

3. The computer-implemented method of claim 1, wherein the temporal information includes one or more of:
time of a day;
day of a week;
day of a month; and
time of a year.

4. The computer-implemented method of claim 1, wherein the information includes at least one of a user's past physical location and current physical location.

5. The computer-implemented method of claim 1, wherein the information includes recorded activities including at least one of:
the user's activities on the social networking system; and
activities on the social network system of users in a community that the user belongs to.

6. The computer-implemented method of claim 1, wherein the information include contemporary events in at least one of:
a physical world; and
a virtual world.

7. The computer-implemented method of claim 1, wherein the information includes demographic information, the demographic information including at least one of:
the user's gender, race, national origin, religion, age, marital status, disability, sexual orientation, education level, and socioeconomic status; and
demographic composition of genders, races, national origins, religions, ages, marital statuses, disabilities, sexual orientations, education levels, and socioeconomic statuses of a community that the user belongs to.

8. The computer-implemented method of claim 1, wherein the new composer prompt is an advertisement.

9. The computer-implemented method of claim 1, further comprising:
collecting statistics of a user's response to the generated new composer prompt to be used in future composer prompt generation.

10. The computer-implemented method of claim 1, wherein the format of the generated composer prompt is based on demographics of the user.

11. A non-transitory computer-readable storage medium having instructions stored therein, which when executed by a processor being implemented in a social networking system, cause the processor to perform a method for generating a composer prompt to induce a user to post a message at the social networking system, the method comprising:
retrieving information about the user stored in a profile at the social networking system;
determining whether a new composer prompt is;
assessing the user information and temporal information to determine content and format of the composer prompt;
generating a new composer prompt based at least partially on an assessment of the information; and
displaying the new composer prompt to the user.

12. The non-transitory computer-readable storage medium of claim 11, wherein the characteristics include temporal information containing at least one of:
time of a day;
day of a week;
day of a month; and
time of a year.

13. The non-transitory computer-readable storage medium of claim 11, wherein the information includes demographic information, the demographic information including at least one of:
the user's gender, race, national origin, religion, age, marital status, disability, sexual orientation, education level, and socioeconomic status; and
demographic composition of genders, races, national origins, religions, ages, marital statuses, disabilities, sexual orientations, education levels, and socioeconomic statuses of a community that the user belongs to.

14. The non-transitory computer-readable storage medium of claim 11, wherein the generating the composer prompt is further based on a need for advertisement, the advertisement being aligned to at least one of:
time of a day, day of a week, day of a month, and time of a year;
a location of the user;
demographics of the user;
contemporary events in at least one of the physical world and a virtual world, the virtual world being an Internet game or a social network system; and
the user's activities on the social networking system.

15. A social networking system, wherein a composer prompt is generated to induce a user to post a message at the social networking system, the social networking system comprising:
a knowledge database configured to store the user information and temporal information; and
a prompt creator configured to retrieve information about the user stored in a profile, the prompt creator further configured to determine whether a new composer prompt is desirable based on a prompt refresh schedule, access the user information and temporal information stored in the knowledge database, generate a new composer prompt based at least partially on an assessment of the information, and display the new composer prompt to the user;

16. The social networking system of claim 15, wherein the knowledge database includes a temporal data module, the temporal data module being configured to store information containing at least one of:
time of a day;
day of a week;
day of a month; and
time of a year.

17. The social networking system of claim 15, wherein the knowledge database includes a location related data module, the location related data module being configured to store information containing at least one of a user's past physical location and current physical location.

18. The social networking system of claim 15, wherein the knowledge database includes:
a user data module configured to store information containing:
demographic information including at least one of user's gender, race, national origin, religion, age, marital status, disability, sexual orientation, education level, and socioeconomic status; and
the user activity information; and
a community data module configured to store information containing:
demographic composition of genders, races, national origins, religions, ages, marital statuses, disabilities, sexual orientations, education levels, and socioeconomic statuses of a community that the user belongs to; and
activities on the social network system of users in a community that the user belongs to.

19. The social networking system of claim 15, wherein the knowledge database includes a sponsor data module, the sponsor data module being configured to store advertisement information for generating an advertisement.

20. The social networking system of claim 15, wherein the knowledge database includes a prompt statistics collector module, the prompt statistics collector module being configured to store collected statistics of responses of the user to the generated new composer prompt to be used in future composer prompt generation.
